(19) United States
(12) Patent Application Publication
(10) Pub. No.: US 2007/0292335 A1
(43) Pub. Date: Dec. 20, 2007

(54) METHOD, SYSTEM, AND DEVICE FOR PRODUCING A STEADY FLOW OF CARBON DIOXIDE

(76) Inventors: Francis X. Webster, Syracuse, NY (US); Christopher V. Sack, Syracuse, NY (US); John R. McLaughlin, Newburgh, NY (US); Darek Czokajlo, West Linn, OR (US); Philipp A. Kirsch, West Linn, OR (US)

Correspondence Address: HOFFMAN WARNICK & D'ALESSANDRO, LLC, 75 STATE STREET, 14TH FLOOR, ALBANY, NY, 12207, US

(21) Appl. No.: 11/424,317

(22) Filed: Jun. 15, 2006

(51) Int. Cl. C01B 31/20; B01J 8/02; B01J 7/00

(52) U.S. Cl. 423/438; 422/305; 422/211

(57) ABSTRACT

The invention provides a method, system, and device for producing a steady flow of carbon dioxide. In one embodiment, the invention may be used as an attractant for an insect species, particularly a hematophagous insect species.

### BACKGROUND OF THE INVENTION

1. Technical Field

The invention relates generally to the field of insect attractants, and more particularly, to the production of a steady flow of carbon dioxide for the prolonged attraction of hematophagous insects for the purpose of collection and/or extermination.

2. Background Art

Methods for trapping and/or killing nuisance or dangerous insects have long been known. Many insecticidal compounds have been developed, some exhibiting specificity for one or a few species. However, the use of such insecticides is generally not targeted. That is, a relatively large quantity is typically applied to an area in which target insects are likely to be present or to an area to be protected from such insects. Such methods of controlling insect populations is therefore both inefficient and potentially hazardous to both humans and non-targeted animals.

Many nuisance and/or dangerous insect species identify and target their prey using respiratory carbon dioxide trails emitted by the prey. As a consequence, a number of methods and devices for drawing such insects to a localized trap using carbon dioxide have been developed.

For example, U.S. Pat. No. 6,209,256 to Brittin et al. teaches an insect trap comprising a trapping medium, through which gaseous carbon dioxide is bubbled. The supply of gaseous carbon dioxide taught by Brittin et al. may be provided by either a chemical reaction (i.e., acid/base reaction) within the trapping medium or by an external supply, such as a pressurized tank of carbon dioxide. However, neither of the methods of Brittin et al. is satisfactory. Production of gaseous carbon dioxide within the trapping medium results in a rapid consumption of the chemical reactants and a high initial production of carbon dioxide followed by a steady decrease in production. Thus, this method is unsuitable for use over an extended period. In addition, the use of an external supply of carbon dioxide requires a user to transport such a supply, which is often bulky and/or heavy, and monitor its consumption, and refill the supply periodically, which may be expensive. These factors make the external carbon dioxide supply of Brittin et al. unsuitable for mobile, temporary, or low-cost applications.

To this extent, a need exists for a method, system, and device for producing a steady flow of carbon dioxide for use in collecting and/or exterminating insects that do not suffer from the defects known in the art.

### SUMMARY OF THE INVENTION

The invention provides a method, system, and device for producing a steady flow of carbon dioxide. In one embodiment, the invention may be used as an attractant for an insect species, particularly a hematophagous insect species.

A first aspect of the invention provides a method for producing a steady flow of carbon dioxide, comprising: providing a closable vessel having a body and a flow regulator; adding to the closable vessel a carbonate source and a weak acid; adding to the carbonate source and the weak acid a quantity of a liquid; and closing the vessel, wherein the carbonate source, the weak acid, and the liquid combine to produce a quantity of carbon dioxide and the flow regulator regulates the release of the carbon dioxide from the closed vessel in a steady manner.

A second aspect of the invention provides a device for producing a steady flow of carbon dioxide, comprising: a vessel having a body and a sealing member; a flow regulating member adapted to regulate a flow of carbon dioxide from within the vessel body to a space outside the vessel body; and a liquid container adapted to dispense a quantity of liquid onto a carbonate source and a weak acid within the vessel body.

A third aspect of the invention provides a system for producing a steady flow of carbon dioxide, comprising: a device including: a vessel having a body and a sealing member; a flow regulating member adapted to regulate a flow of carbon dioxide from within the vessel body to a space outside the vessel body; and a liquid container adapted to dispense a quantity of liquid within the vessel body; a carbonate source; and a weak acid, wherein dispensation of the liquid onto the carbonate source and the weak acid within the vessel body produces a quantity of carbon dioxide and the release of the carbon dioxide from the vessel body is regulated by the regulating member in a steady manner.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1A shows an illustrative device according to the invention.

FIG. 1B shows a detailed view of the flow regulating member of FIG. 1A.

FIG. 2 shows a flow diagram of illustrative methods according to the invention.

FIG. 3 shows a graph of various rates of carbon dioxide flow achievable by the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method, system, and device for producing a steady flow of carbon dioxide.

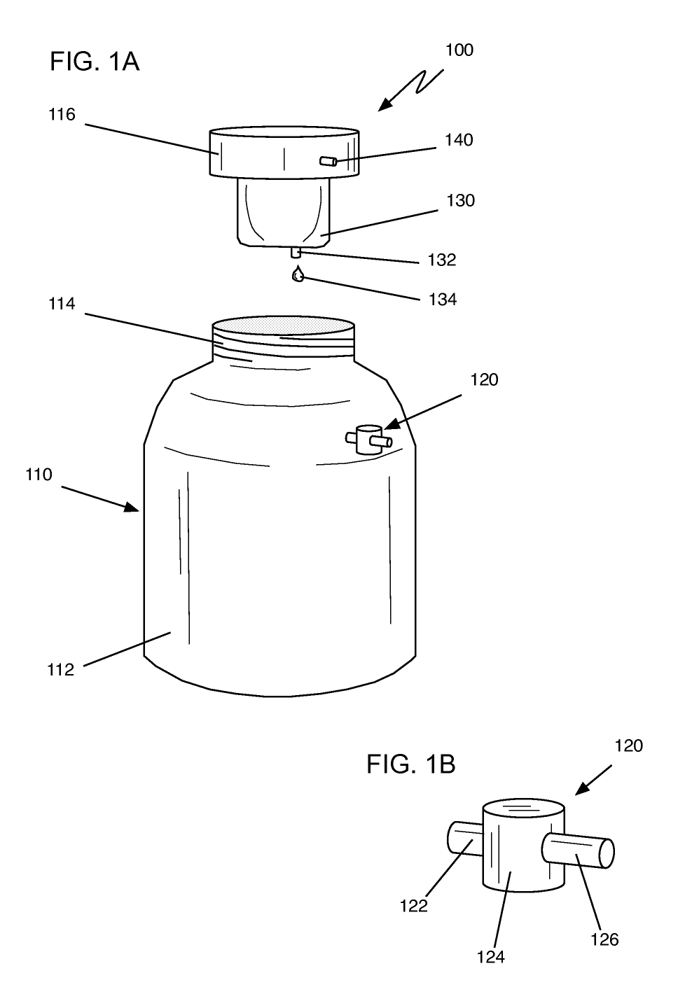

FIG. 1 shows an illustrative device 100 according to the invention. Device 100 comprises a vessel 110 having a body 112 and a cap 116 adapted to seal vessel 110 at the vessel's neck 114. As shown in FIG. 1, cap 116 and neck 114 are compatibly threaded, although any device, mechanism, or method may be used to secure cap 116 to neck 114. Similarly, while shown as a cap 116, any sealing member capable of alternately allowing access into body 112 and forming a substantially airtight seal in body 112 may be employed.

As will be explained in greater detail below, the production of carbon dioxide according to the invention includes the slow dispensation of a liquid, preferably water, onto a mixed carbonate source and weak acid within body 112. Accordingly, cap 116 (or, optionally, body 112) includes an apparatus for supplying such a liquid. In FIG. 1, an underside of cap 116 includes a flexible bag 130 capable of holding a quantity of liquid. Bag 130 includes a drip member 132 adapted to slowly dispense the contents of bag 130 (e.g., as individual drops 134). Alternatively, cap 116 may be fitted with a stem 140 for connection of device 100 to an external source of liquid, which may be slowly dispensed into body 112.

The production of carbon dioxide according to the invention includes the slow dispensation of a liquid into body 112, which contains a mixed carbonate source and a weak acid. Suitable carbonate sources include, for example, limestone (calcite), sodium bicarbonate, trona, dolomite, magnesite, and natrite. Other carbonate sources may also be employed, as will be recognized by one skilled in the art. Suitable weak acids include, for example, citric acid, acetic acid, tartaric acid, acetic anhydride, acetyl chloride, 1,3-acetone dicarboxylic acid, succinic anhydride, formic acid, trichloroacetic acid, hydrofluoric acid, and hydrocyanic acid. Other weak acids may also be employed, as will be recognized by one skilled in the art. The preferred combination of carbonate source and weak acid is limestone (calcite) and citric acid, respectively, each in powder form.

As noted above, once the carbonate source and weak acid are added to body 112, a liquid is slowly dispensed onto the carbonate source and weak acid to produce a quantity of carbon dioxide. The preferred liquid is water, although virtually any aqueous liquid may be used. The liquid is dispensed onto the carbonate source and weak acid slowly, e.g., at a rate between about 0.5 mL per minute and about 2.0 mL per minute, although slower or faster rates may also be employed. Typically, bag 130 is adapted to contain up to approximately 1000 mL of liquid. Accordingly, such a quantity of liquid may be dispensed over a period of between about eight hours and about 36 hours.

In order to ensure a steady flow of carbon dioxide from device 100, once dispensation of the liquid from bag 130 into body 112 has begun, cap 116 is attached to neck 114 and the release of carbon dioxide from vessel 110 controlled by flow regulating member 120. FIG. 1B shows a detailed view of flow regulating member 120, including a tap 122 for passage through body 112, a regulating device 124, and a port 126 for connection to flexible tubing or another apparatus for delivering the carbon dioxide to a site of intended use. Any number and arrangement of flow-regulating devices known in the art may be used, that depicted in FIGS. 1A-B being merely illustrative of suitable devices and arrangements. In addition, while flow regulating member 120 is shown on a surface of body 112, this is merely a preferred location and is not essential. Flow regulating member 120 may be located on cap 116 or any other portion of vessel 110.

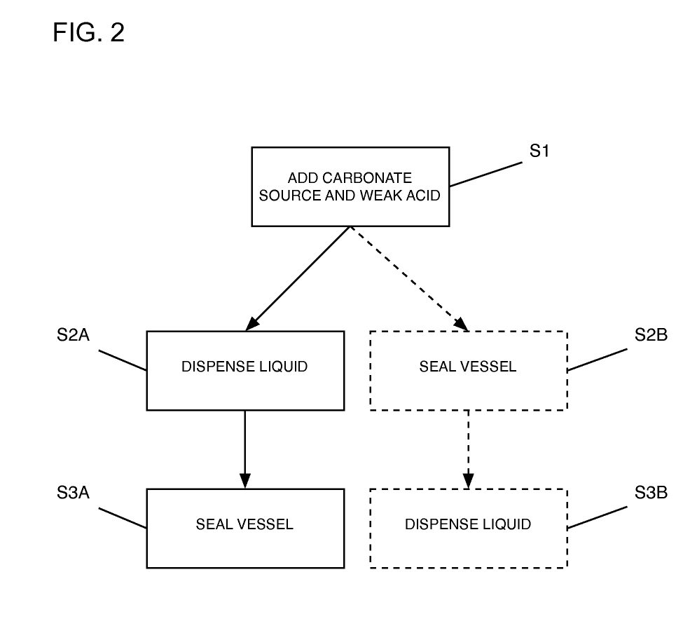

FIG. 2 shows a flow diagram of alternative illustrative methods according to the invention. At step S1, a carbonate source and a weak acid are added to body 112 of vessel 110 (FIG. 1A). At step S2A, a liquid is slowly dispensed from bag 120 onto the carbonate source and weak acid added at step S1. At step S3A, the vessel 110 is sealed, upon which the release of carbon dioxide is regulated by flow regulating member 120. Alternatively, in the case that an external supply of liquid is used (i.e., by connection to stem 140 (FIG. 1A), vessel 110 may be sealed at step S2B and the liquid then dispensed at step S3B.

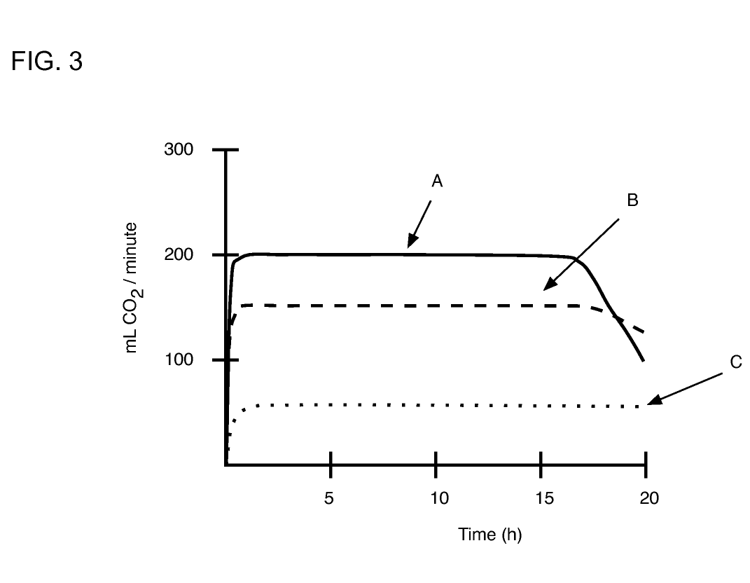

FIG. 3 shows a chart of three flows A, B, C of carbon dioxide using three mixtures of limestone (calcite) and citric acid and a device according to FIG. 1. Flow A was produced using 540 g of limestone, 411 g of acetic acid, and 500 mL of water dispensed at a rate of approximately 1 mL per minute. A maximum carbon dioxide flow rate of approximately 200 mL per minute was achieved within one minute and remained steady for approximately 16 hours, after which the rate steadily declined to approximately 100 mL per minute by hour 20.

Flow B was produced using 400 g of limestone, 310 g of citric acid, and 375 mL of water dispensed at a rate of approximately 1 mL per minute. A maximum carbon dioxide flow rate of approximately 150 mL per minute was achieved within one minute and remained steady for approximately 18 hours, after which the rate steadily declined to approximately 125 mL per minute by hour 20.

Flow C was produced using 270 g of limestone, 205 g of citric acid, and 250 mL of water dispensed at a rate of approximately 1 mL per minute. A maximum carbon dioxide flow rate of approximately 50 mL per minute was achieved within one minute and remained steady throughout the 20-hour sampling period. In fact, although not shown in FIG. 3, flow C was maintained at approximately 50 mL per minute for 36 hours. By adjusting flow regulating member 120 (FIGS. 1A-B), the same quantities of components used to produce flow C may be used to produce a flow rate of approximately 100 mL per minute, with such a flow rate remaining steady for approximately 18 hours.

As will be recognized by one having skill in the art, by manipulating the types and quantities of carbonate source and weak acid, and by adjusting flow regulating member 120, a substantially steady flow of carbon dioxide at almost any rate can be produced over an extended period (e.g., about 36 hours).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims. For example, while the steady flow of carbon dioxide produced according to the invention has been described as useful as an attractant for insect species, other uses for a steady flow of gaseous carbon dioxide are also possible and within the scope of the present invention.

What is claimed is:

1. A method for producing a steady flow of carbon dioxide, comprising:
providing a sealable vessel having a body and a flow regulator;
adding to the sealable vessel a carbonate source and a weak acid;
adding to the carbonate source and the weak acid a quantity of a liquid; and
sealing the vessel,
wherein the carbonate source, the weak acid, and the liquid combine to produce a quantity of carbon dioxide and the flow regulator regulates the release of the carbon dioxide from the sealed vessel in a steady manner.

2. The method of claim 1, wherein the carbonate source is selected from a group consisting of: calcite, sodium bicarbonate, trona, dolomite, magnesite, and natrite.

3. The method of claim 1, wherein the weak acid is selected from a group consisting of: citric acid, acetic acid, tartaric acid, acetic anhydride, acetyl chloride, 1,3-acetone dicarboxylic acid, succinic anhydride, formic acid, trichloroacetic acid, hydrofluoric acid, and hydrocyanic acid.

4. The method of claim 1, wherein the carbonate source and the weak acid is each in powder form.

5. The method of claim 1, wherein the liquid includes water.

6. The method of claim 1, wherein the liquid is added to the carbonate source and the weak acid over a period of between about one hour and about 36 hours.

7. The method of claim 1, wherein the carbon dioxide is released at a rate of between about 50 milliliters per minute and about 300 milliliters per minute for a period of between about eight hours and about 36 hours.

8. A device for producing a steady flow of carbon dioxide, comprising:
a vessel having a body and a sealing member;
a flow regulating member adapted to regulate a flow of carbon dioxide from within the vessel body to a space outside the vessel body; and
a liquid container adapted to dispense a quantity of liquid onto a carbonate source and a weak acid within the vessel body.

9. The device of claim 8, wherein the liquid container is adapted to dispense the quantity of liquid onto the carbonate source and the weak acid over a period of between about one hour and about 36 hours.

10. The device of claim 8, wherein the liquid container is adapted to reside within the vessel during dispensation of the quantity of liquid.

11. The device of claim 8, wherein the flow regulating member is adapted to release the carbon dioxide at a rate of between about 50 milliliters per minute and about 300 milliliters per minute for a period of between about eight hours and about 36 hours.

12. The device of claim 8, wherein the flow of carbon dioxide regulated by the flow regulating member is adjustable.

13. A system for producing a steady flow of carbon dioxide, comprising:
a device including:
a vessel having a body and a sealing member;
a flow regulating member adapted to regulate a flow of carbon dioxide from within the vessel body to a space outside the vessel body; and
a liquid container adapted to dispense a quantity of liquid within the vessel body;
a carbonate source; and
a weak acid,
wherein dispensation of the liquid onto the carbonate source and the weak acid within the vessel body produces a quantity of carbon dioxide and the release of the carbon dioxide from the vessel body is regulated by the regulating member in a steady manner.

14. The system of claim 13, wherein the liquid container is adapted to dispense the quantity of liquid onto the carbonate source and the weak acid over a period of between about one hour and about 36 hours.

15. The system of claim 13, wherein the liquid container is adapted to reside within the vessel during dispensation of the quantity of liquid.

16. The system of claim 13, wherein the flow regulating member is adapted to release the carbon dioxide at a rate of between about 50 milliliters per minute and about 300 milliliters per minute for a period of between about eight hours and about 36 hours.

17. The system of claim 13, wherein the carbonate source is selected from a group consisting of: calcite, sodium bicarbonate, trona, dolomite, magnesite, and natrite.

18. The system of claim 13, wherein the weak acid is selected from a group consisting of: citric acid, acetic acid, tartaric acid, acetic anhydride, acetyl chloride, 1,3-acetone dicarboxylic acid, succinic anhydride, formic acid, trichloroacetic acid, hydrofluoric acid, and hydrocyanic acid.

19. The system of claim 13, wherein the carbonate source and the weak acid is each in powder form.

20. The system of claim 13, wherein the liquid includes water.
